(19) United States
(12) Patent Application Publication
(10) Pub. No.: US 2010/0284756 A1
(43) Pub. Date: Nov. 11, 2010

(54) TOOL CLAMPING DEVICE OF TOOL SEAT

(76) Inventor: Fu-Hsiang TUNG, Bulimba (AU)

Correspondence Address: Ching-Ling Huang, 5597 NW 127th Ter, Portland, OR, 97229, US

(21) Appl. No.: 12/463,427

(22) Filed: May 11, 2009

(51) Int. Cl. B23B 31/10; B23Q 3/12

(52) U.S. Cl. 409/233; 279/4.01

(57) ABSTRACT

A tool clamping device of a tool seat is installed on a multifunctional machining center for firmly securing a tool having a steel ball collar and comprises a spindle, a disc-type spring, a draw rod, a hydraulic member and a steel ball. The draw rod is able to slide with respect to the spindle, pressed by the disc-type spring to contact the spindle, and pushed by the hydraulic member to separate from the spindle. The draw rod has a draw ring, and the steel ball is accommodated in the draw ring. The disc-type spring presses the draw rod and makes the draw ring push the steel ball outward and latch the steel ball collar of the tool, whereby the tool is firmly secured. The hydraulic member applies pressure to move the draw ring to accommodate the steel ball, whereby the tool is released.

### FIELD OF THE INVENTION

The present invention relates to a tool clamping device of a multifunctional machining center, particularly to a compact tool clamping device of a tool seat, whereby tools can be fast exchanged.

### BACKGROUND OF THE INVENTION

The conventional manual tool clamping device of a multifunctional machining center comprises a draw rod, a rotation block, a gripper, a fixing block and a spring. The user rotates the rotation block with the draw rod, and the elastic force of the spring pushes the fixing block to slide via the irregular cross section of the rotation block to close and open the gripper, whereby the tool is clamped or released. The conventional manual tool clamping device needs a longer time to exchange tools.

To automate tool exchanging, a conventional automatic tool clamping device comprises a gripper, a spring and a displacement member. The displacement member is driven to slide, and the spring restores the displacement member to a given position. Therefore, automating the moving of the displacement member can automate the opening and closing of the gripper. The conventional automatic tool clamping device needs a longer displacement for the sliding of the gripper and a greater space for the opening and closing of the gripper. Therefore, tool exchanging is hard to undertaken in a limited space.

### SUMMARY OF THE INVENTION

The primary objective of the present invention is to provide a manual/automatic tool clamping device, which has a short stroke of tool exchanging and needs less time and space for tool exchanging, whereby is achieved a compact tool clamping device of a tool seat.

To achieve the abovementioned objective, the present invention proposes a tool clamping device of a tool seat, which is installed on a multifunctional machining center and used to firmly secure a tool having a steel ball collar, and which comprises a spindle, a disc-type spring, a draw rod, a hydraulic member and a steel ball. The spindle has an accommodation space accommodating the disc-type spring. The draw rod is installed inside the accommodation space, able to slide with respect to the spindle, and pressed by the disc-type spring to contact the spindle. The draw rod has a draw ring. The hydraulic member is arranged close to the draw rod and applies pressure to separate the draw rod from the spindle. The steel ball is accommodated in the draw ring. The disc-type spring presses the draw rod and makes the draw ring push the steel ball outward and latch the steel ball collar of the tool, whereby the tool is secured firmly. The hydraulic member applies pressure to move the draw ring to accommodate the steel ball, whereby the tool is released.

As the present invention uses a steel ball and a draw ring to secure the tool, the draw rod of the tool clamping device of the present invention has a shorter stroke. Therefore, manual or automatic tool exchanging needs a smaller space in the present invention than in the conventional technologies.

### BRIEF DESCRIPTION OF THE DRAWINGS

FIG. 1 is a perspective view schematically showing the appearance of a tool clamping device according to the present invention;

FIG. 2 is a sectional view schematically showing a tool clamping device according to the present invention;

FIG. 3 is a perspective view schematically showing that a tool is clamped by a tool clamping device according to the present invention;

FIG. 4A is a sectional view schematically showing that a tool is clamped by a tool clamping device according to the present invention;

FIG. 4B is a sectional view schematically showing that a tool is released from a tool clamping device according to the present invention;

FIG. 5 is a perspective view schematically showing a second collar of a tool clamping device according to the present invention;

FIG. 6 is a perspective view schematically showing a first collar of a tool clamping device according to the present invention; and

FIG. 7 is a sectional view schematically showing another embodiment according to the present invention.

### DETAILED DESCRIPTION OF THE PREFERRED EMBODIMENTS

Below, the embodiments are described in detail to demonstrate the technical contents of the present invention. However, the embodiments are only to exemplify the present invention but not to limit the scope of the present invention.

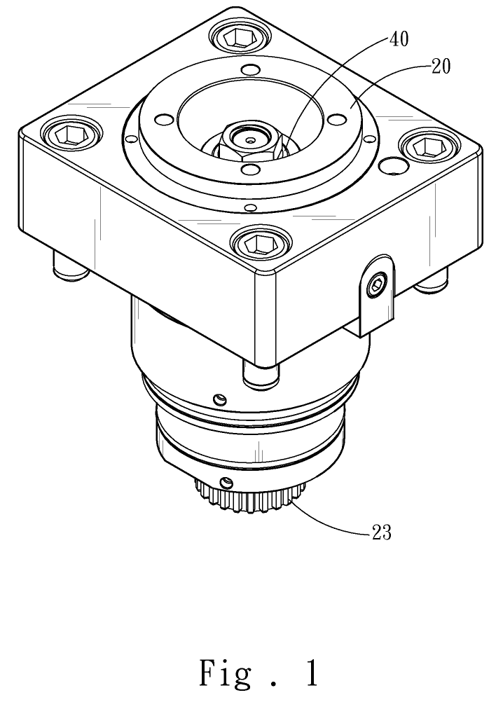

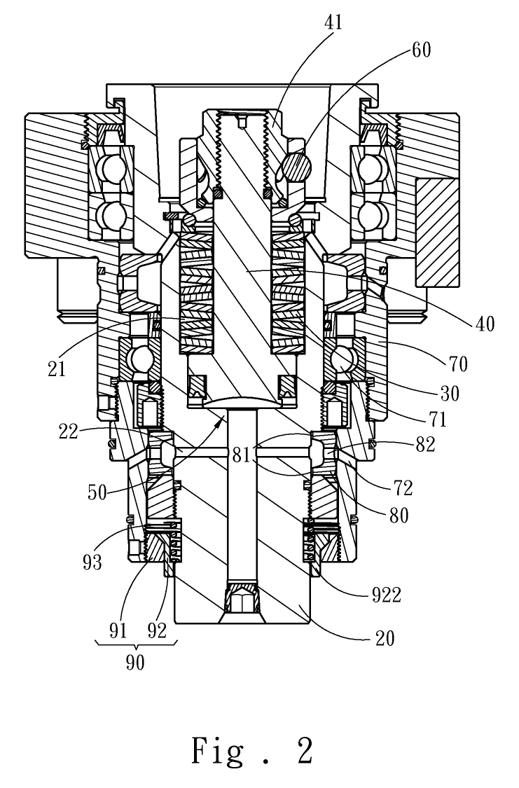

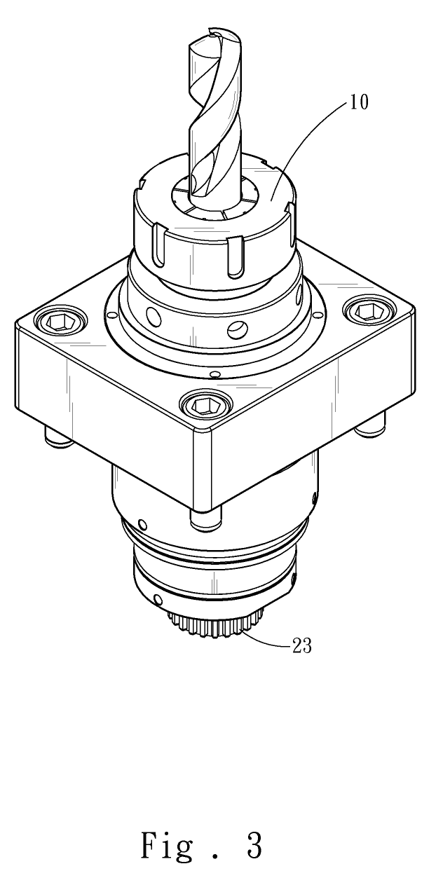

Refer to from FIG. 1 to FIG. 4B. The tool clamping device of the present invention is installed on a multifunctional machining center (not shown in the drawings) for firmly securing a tool 10 having a steel ball collar 11 and comprises a spindle 20, a disc-type spring 30, a draw rod 40, a hydraulic member 50 and a steel ball 60. The spindle 20 has an accommodation space 21 accommodating the disc-type spring 30. The disc-type spring 30 may be a compression spring. The draw rod 40 is installed inside the accommodation space 21, able to slide with respect to the spindle 20, and pressed by the disc-type spring 30 to contact the spindle 20. The draw rod 40 has a draw ring 41.

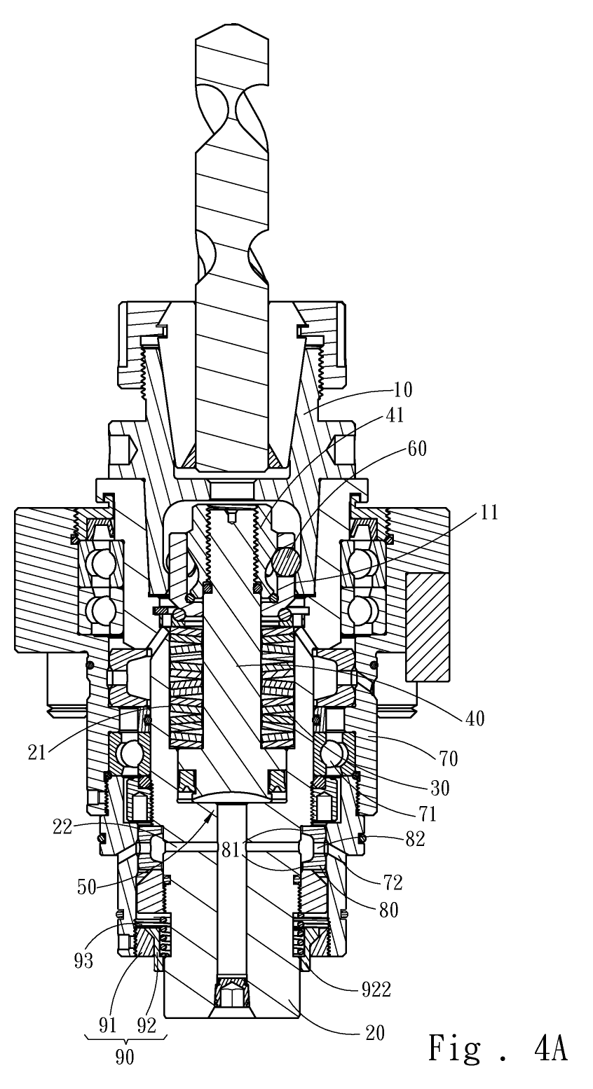

The hydraulic member 50 is arranged close to the draw rod 40 and applies pressure to separate the draw rod 40 from the spindle 20. The steel ball 60 is accommodated in the draw ring 41. The disc-type spring 30 presses the draw rod 40 and makes the draw ring 41 push the steel ball 60 outward and latch the steel ball collar 11 of the tool 10, whereby the tool 10 is secured firmly, as shown in FIG. 4A. The hydraulic member 50 applies pressure to move the draw ring 41 to accommodate the steel ball 60, whereby the tool 10 is released, as shown in FIG. 4B.

The present invention further comprises a tool seat 70, and the spindle 20 is rotatably installed in the tool seat 70 via at least one bearing 71. At least one planar oil seal 80 is arranged between the tool seat 70 and the spindle 20. The spindle 20 and the tool seat 70 respectively have hydraulic pipings 22 and 72. The planar oil seal 80 has two flanges 81 and at least one through-hole 82. The flanges 81 are compressed to press against the spindle 20 and encase the hydraulic piping 22 with the through-hole 82 exactly facing the hydraulic piping 72 of the tool seat 70.

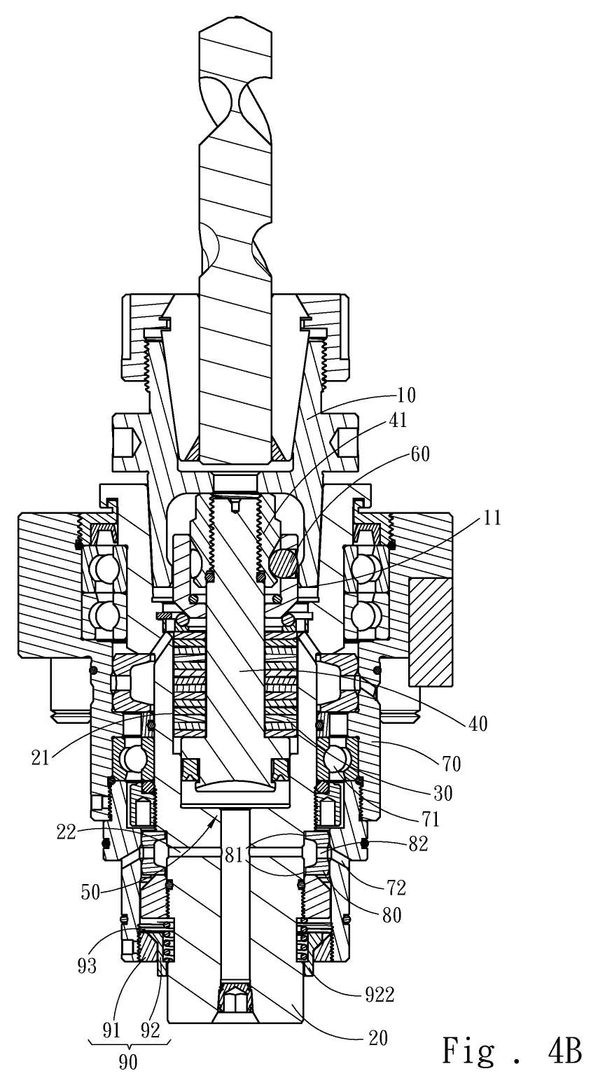

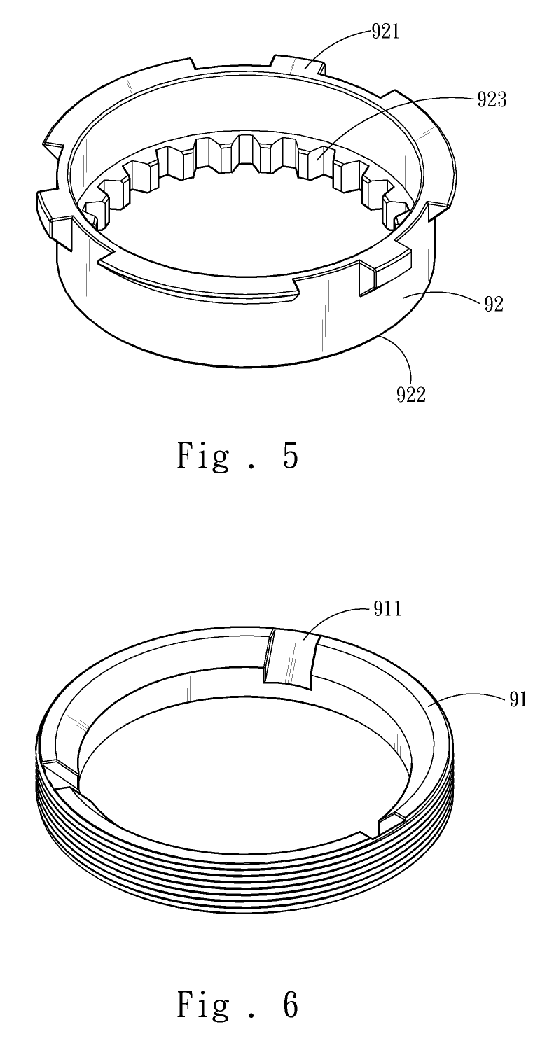

Refer to FIG. 5 and FIG. 6. An angle-positioning device 90 is arranged between the tool seat 70 and the spindle 20. The angle-positioning device 90 has a first collar 91, a second collar 92, and a spring 93. The spring 93 applies force to make the first collar 91 sleeve and contact the second collar 92. The first collar 91 has at least one latch slot 911, and the second collar 92 has at least one protrusion 921. When the first collar 91 is rotated to a specified angle with respect to the second collar 92, the protrusion 921 is fitted into the latch slot 911. A push member 922 extends from the second collar 92. When installed in a multifunctional machining center, the spindle 20 presses against the push member 922 and makes the spring 93 compressed, whereby the protrusion 921 is separated from the latch slot 911.

The first collar 91 can be screwed to engage with the tool seat 70. The second collar 92 has an annular inner concave gear 923, and the spindle 20 has an annular outer gear 23 corresponding to the inner concave gear 923. The inner concave gear 923 can latch with the outer gear 23, and the spindle 20 can slide axially into the second collar 92 to engage with the second collar 92.

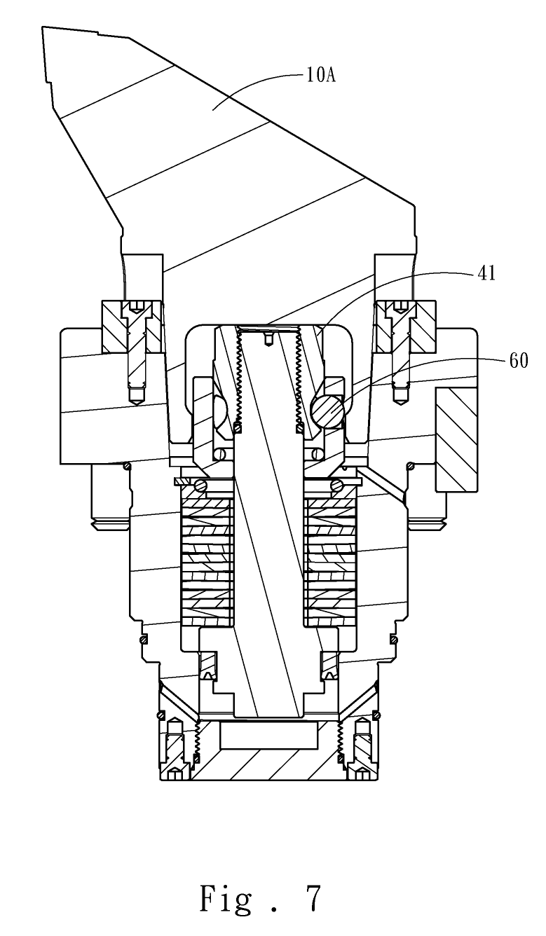

Refer to FIG. 7 for another embodiment of the present invention. The present invention can also apply to non-powered tool seats. Similar to the embodiment described above, the steel ball 60 and the draw ring 41 cooperates to firmly secure a tool 10A in this embodiment. In this embodiment, tool exchanging can also be undertaken in a smaller space.

In conclusion, the present invention uses the steel ball 60 and the draw ring 41 to secure and release the tool 10, wherein the draw rod 40 has a stroke shorter than the conventional clamping device. Therefore, manual or automatic tool exchanging needs a smaller space in the present invention. The present invention also discloses the planar oil seal 80, which can form planar contact to provide better airtightness. Further, the present invention also discloses the angle-positioning device 90, which enables the spindle 20 to have a specified angle with respect to the tool seat 70, whereby the outer gear 23 of the spindle 20 can precisely mate with the multifunctional machining center without collision of gear teeth.

What is claimed is:

1. A tool clamping device of a tool seat, which is installed on a multifunctional machining center for firmly secure a tool having a steel ball collar, comprising
a spindle having an accommodation space;
a disc-type spring accommodated in said accommodation space;
a draw rod installed inside said accommodation space, able to slide with respect to said spindle, pressed by said disc-type spring to contact said spindle, and having a draw ring;
a hydraulic member arranged close to said draw rod and applying pressure to separate said draw rod from said spindle; and
a steel ball accommodated in said draw ring,
wherein said disc-type spring presses said draw rod and makes said draw ring push said steel ball outward and latch said steel ball collar of said tool, whereby said tool is secured firmly, and
wherein said hydraulic member applies pressure to move said draw ring to accommodate said steel ball, whereby said tool is released.

2. The tool clamping device of a tool seat according to claim 1, wherein said disc-type spring is a compression spring.

3. The tool clamping device of a tool seat according to claim 1 further comprising a tool seat, wherein said spindle is rotatably installed in said tool seat via at least one bearing.

4. The tool clamping device of a tool seat according to claim 3, wherein at least one planar oil seal is arranged between said tool seat and said spindle; said spindle and said tool seat respectively have a hydraulic piping; said planar oil seal has two flanges and at least one through-hole; said flanges are compressed to press against said spindle and encase said hydraulic piping with said through-hole exactly facing said hydraulic piping of said tool seat.

5. The tool clamping device of a tool seat according to claim 3, wherein an angle-positioning device is arranged between said tool seat and said spindle; said angle-positioning device has a first collar, a second collar, and a spring; said spring applies force to make said first collar sleeve and contact said second collar; said first collar has at least one latch slot, and said second collar has at least one protrusion; when said first collar is rotated to a specified angle with respect to said second collar, said protrusion is fitted into said latch slot; a push member extends from said second collar; when installed in a multifunctional machining center, said spindle presses against said push member and makes said spring compressed to separate said protrusion from said latch slot.

6. The tool clamping device of a tool seat according to claim 5, wherein said first collar is screwed to engage with said tool seat; said second collar has an annular inner concave gear, and said spindle has an annular outer gear corresponding to said inner concave gear; said inner concave gear mates with said outer gear, and said spindle slides axially into said second collar to engage with said second collar.
